(19) United States
(12) Patent Application Publication
(10) Pub. No.: US 2026/0119164 A1
(43) Pub. Date: Apr. 30, 2026

(54) SYSTEMS AND METHODS FOR VALIDATING A SOFTWARE PACKAGE

(71) Applicant: THE BANK OF NEW YORK MELLON, New York, NY (US)

(72) Inventors: Marc OREN, New York, NY (US); Vinay THAKER, New York, NY (US)

(21) Appl. No.: 18/930,669

(22) Filed: Oct. 29, 2024

(51) Int. Cl. G06F 8/71; G06F 8/41; G06F 8/60

(52) U.S. Cl. CPC G06F 8/71; G06F 8/433; G06F 8/60

(57) ABSTRACT

Systems and methods for validating a software package receive a software package, in which the software package includes a plurality of software products; identify any components, libraries, software dependencies, or metadata among the plurality of software products in the software package; upon build of the software package, generate a first software bill of materials (SBOM) based on the identified components, libraries, software dependencies, or metadata; register the first SBOM in an SBOM registry; upon deployment of the software package to an environment, generate a second SBOM based on the deployed software package; and compare the first SBOM registered in the SBOM registry with the second SBOM to validate the software package.

### BACKGROUND

Current methods by which software and systems are deployed in an environment can have various flaws. Validation procedures for confirmation of all components of a software product do not exist. Software products are typically built on primary and transitive dependencies in their software stack and all of these dependencies must be validated and consistently revalidated. Software bill of materials (referred to as SBOMs) are only a recent focus in industry with Executive Order (EO) 14028 released by the White House in 2021.

### SUMMARY

Aspects of the disclosure relate to methods, apparatuses, and/or systems for validating a software package.

In some aspects, the techniques described herein relate to a method for validating a software package, including: receiving, by a processor, a software package, wherein the software package includes a plurality of software products; identifying, by the processor, any components, libraries, software dependencies, or metadata among the plurality of software products in the software package; upon build of the software package, generating, by the processor, a first software bill of materials (SBOM) based on the identified components, libraries, software dependencies, or metadata; registering, by the processor, the first SBOM in an SBOM registry; upon deployment of the software package to an environment, generating, by the processor, a second SBOM based on the deployed software package; and comparing, by the processor, the first SBOM registered in the SBOM registry with the second SBOM to validate the software package.

In some aspects, the techniques described herein relate to a method, wherein, when identifying software dependencies of the software package, the processor is configured to identify at least one of primary or transitive software dependencies between various software products in the software package.

In some aspects, the techniques described herein relate to a method, wherein, when comparing the first SBOM and the second SBOM, the processor is further configured to verify that all identified primary and transitive software dependencies match between the first SBOM and the second SBOM.

In some aspects, the techniques described herein relate to a method, further including: during operation, scanning, by the processor, the environment for the deployed software package; generating, by the processor, a third SBOM; and comparing, by the processor, the first SBOM registered in the SBOM registry with the third SBOM to revalidate the software package.

In some aspects, the techniques described herein relate to a method, further including generating an alert when the comparison of the first SBOM and second SBOM results in a mismatch.

In some aspects, the techniques described herein relate to a method, further including generating an alert when the comparison of the first SBOM and third SBOM results in a mismatch.

In some aspects, the techniques described herein relate to a method, wherein, when comparing the first SBOM and the second SBOM, the processor is configured to compare metadata attributes of each SBOM; and confirm whether the metadata attributes are the same for the first SBOM and the second SBOM.

In some aspects, the techniques described herein relate to a method, wherein, when comparing the first SBOM and the third SBOM, the processor is configured to compare metadata attributes of each SBOM; and confirm whether the metadata attributes are the same for the first SBOM and the third SBOM.

In some aspects, the techniques described herein relate to a system for validating a software package, including: memory storing computer program instructions; and one or more processors configured to execute the computer program instructions to: receive a software package, wherein the software package includes a plurality of software products; identify any components, libraries, software dependencies, or metadata among the plurality of software products in the software package; upon build of the software package, generate a first software bill of materials (SBOM) based on the identified components, libraries, software dependencies, or metadata; register the first SBOM in an SBOM registry; upon deployment of the software package to an environment, generate a second SBOM based on the deployed software package; and compare the first SBOM registered in the SBOM registry with the second SBOM to validate the software package.

In some aspects, the techniques described herein relate to a system, wherein, when identifying software dependencies of the software package, the one or more processors are configured to identify at least one of primary or transitive software dependencies between various software products in the software package.

In some aspects, the techniques described herein relate to a system, wherein, when comparing the first SBOM and the second SBOM, the one or more processors are further configured to verify that all identified primary and transitive software dependencies match between the first SBOM and the second SBOM.

In some aspects, the techniques described herein relate to a system, further configured to: during operation, scan the environment for the deployed software package; generate a third SBOM; and compare the first SBOM registered in the SBOM registry with the third SBOM to revalidate the software package.

In some aspects, the techniques described herein relate to a system, further configured to generate an alert when the comparison of the first SBOM and second SBOM results in a mismatch.

In some aspects, the techniques described herein relate to a system, further figured to generate an alert when the comparison of the first SBOM and third SBOM results in a mismatch.

In some aspects, the techniques described herein relate to a system, wherein, when comparing the first SBOM and the second SBOM, the one or more processors are configured to compare metadata attributes of each SBOM; and confirm whether the metadata attributes are the same for the first SBOM and the second SBOM.

In some aspects, the techniques described herein relate to a system, wherein, when comparing the first SBOM and the third SBOM, the one or more processors are configured to compare metadata attributes of each SBOM; and confirm whether the metadata attributes are the same for the first SBOM and the third SBOM.

In some aspects, the techniques described herein relate to a non-transitory computer readable medium having instructions recorded thereon for validating a software package, the instructions when executed by a computer having at least one programmable processor cause operations including: receiving, by the processor, a software package, wherein the software package includes a plurality of software products; identifying, by the processor, any components, libraries, software dependencies, or metadata among the plurality of software products in the software package; upon build of the software package, generating, by the processor, a first software bill of materials (SBOM) based on the identified components, libraries, software dependencies, or metadata; registering, by the processor, the first SBOM in an SBOM registry; upon deployment of the software package to an environment, generating, by the processor, a second SBOM based on the deployed software package; and comparing, by the processor, the first SBOM registered in the SBOM registry with the second SBOM to validate the software package.

In some aspects, the techniques described herein relate to a non-transitory computer readable medium, wherein, when identifying software dependencies of the software package, the processor is configured to identify at least one of primary or transitive software dependencies between various software products in the software package.

In some aspects, the techniques described herein relate to a non-transitory computer readable medium, wherein, when comparing the first SBOM and the second SBOM, the processor is further configured to verify that all identified primary and transitive software dependencies match between the first SBOM and the second SBOM.

In some aspects, the techniques described herein relate to a non-transitory computer readable medium, further including: during operation, scanning, by the processor, the environment for the deployed software package; generating, by the processor, a third SBOM; and comparing, by the processor, the first SBOM registered in the SBOM registry with the third SBOM to revalidate the software package.

Various other aspects, features, and advantages will be apparent through the detailed description and the drawings attached hereto. It is also to be understood that both the foregoing general description and the following detailed description are exemplary and not restrictive of the scope of the disclosure.

### BRIEF DESCRIPTION OF THE FIGURES

FIG. 1 depicts an example software product with various primary and transitive software dependencies;

FIG. 2 depicts an illustrative system for providing validation of a software package, in accordance with at least one embodiment;

FIG. 3 depicts an example method for providing validation of a software package, in accordance with at least one embodiment; and

FIG. 4 depicts an example computer system on which systems and methods described herein may be executed, in accordance with at least one embodiment.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION

In the following description, for the purposes of explanation, numerous specific details are set forth in order to provide a thorough understanding of the various embodiments. It will be appreciated, however, by those having skill in the art, that the embodiments may be practiced without these specific details, or with an equivalent arrangement. In other cases, well-known structures and devices are shown in block diagram form in order to avoid unnecessarily obscuring the embodiments.

To mitigate the problems described herein, the inventors had to both invent solutions and, in some cases just as importantly, recognize problems overlooked (or not yet foreseen) by others in the field of automating the provision of evaluation requests. Indeed, the inventors wish to emphasize the difficulty of recognizing those problems that are nascent and will become much more apparent in the future should trends in industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

Embodiments provide systems and methods for securing the supply chain of software delivery from acquisition through installation, such that the software installed is the intended software and only the intended software. The dependency chain of primary and transitive dependencies must be registered at build, confirmed at deployment, and monitored during operation that the Software is valid throughout the stack. By leveraging the processes and procedures required to generate artifacts at "build" to delivered artifacts at deploy, a comparison method may confirm the intended software was delivered to its target. Leveraging a master registry of the correct component parts from an SBOM repository, a comparison may be used to validate that the planned delivery matches the actual delivery.

Current procedures for code signature confirmation do not test primary and transitive dependencies throughout the software stack against any known “good”. Accordingly, systems and methods to securely test Free and Open Source Software (FOSS), Commercial off the Shelf Software (COTS), and/or internally developed software (collectively, “software”) into an organization are provided herein. When delivering software into an environment, delivery methods exist to install the product and validate its functionality, but delivery methods do not exist to test the validity of the software package. Systems and methods described herein may be executed to validate the delivered product, inclusive of its dependencies, and to test the artifacts delivered.

A SBOM describes the internal elements or pieces of a software product. A software product may include many pieces of additional software products. Each of these software products may also be composed of additional software products. These dependent relationships are described as primary and transitive software dependencies. A SBOM is typically generated through an automated process using specialized tools that scan the software’s source code or binaries to identify all components, including libraries, dependencies, and third-party packages. These tools analyze the package manifests (e.g., package.json, pom.xml, or requirements.txt), binary files, or compiled code to extract information about the software's components. The next step typically involves dependency scanning, where the tools use package managers to gather details about each dependency, such as its version, licensing information, and any sub-dependencies. This process creates a comprehensive dependency tree of the software’s structure. Once identified, the tools collect metadata about each component, including licenses and known vulnerabilities, often referencing vulnerability databases like the National Vulnerability Database (NVD). The SBOM is then typically formatted into standard file formats, such as CycloneDX, SPDX, or SWID, which may enable it to be machine-readable and easily shared. Many organizations integrate SBOM generation into their Continuous Integration/Continuous Delivery (CI/CD) pipelines, so it is automatically updated with each new build or dependency change. Once generated, the SBOM is typically validated, stored alongside the software artifacts, and distributed for compliance, security, and transparency purposes.

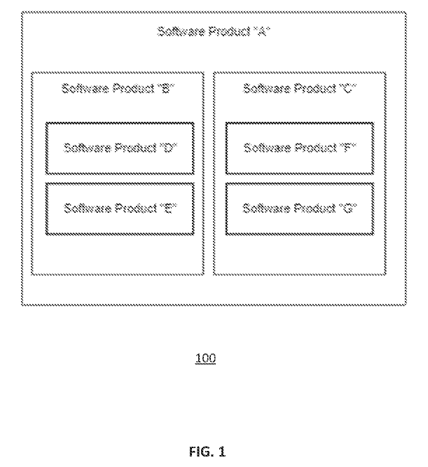

FIG. 1 depicts an example software product with various primary and transitive software dependencies. As shown in FIG. 1, a piece of software may be composed of many additional pieces of software. In this example, the Software Product A has two primary (direct) dependencies. Software Product A declares that it requires both Software Product B and Software Product C in order to function. Software Product B and Software Product C also declare their own primary dependencies, Software Product D, Software Product E, Software Product F and Software Product G, respectively. Software Product B’s and Software Product C’s primary dependencies, Software Product D, Software Product E, Software Product F, and Software Product G, are transitive dependencies to Software Product A as Software Product A inherits the dependency from Software Product B and Software Product C. Software Product A has primary dependencies of Software Product B and Software Product C and transitive dependencies of Software Product D, Software Product E, Software Product F, and Software Product G.

Various embodiments of the systems and methods described herein may leverage an IT Asset management system (referred to herein as “ITAM”). ITAM may enable applications to track financial, contractual, inventory, and/or other data of IT assets across their lifecycle. This combination of applications attributes enables governance of assets against an organization’s standards and risk tolerance. ITAM tracks an application and its relevant relationships, e.g., Host Inventory, Expense, Jobs, Programming Languages, etc. It is not limited to these subjects, as they represent a sample of the possible relationships ITAM may track for an application. ITAM may also track a number of attributes specific to the application, e.g., Ownership, RTO, Lifecycle, Organization Hierarchy, etc.

In some embodiments, ITAM may require certification and recertification of its data values from its constituent users and the respective owners of these applications. Furthermore, running discovery tools on the network may require that ITAM knows all of an application’s hardware and can invoke a method to retrieve that data. With this in place, a discovery application can scan the host for installed products and report on these products back to ITAM for cataloging against the application.

As understood herein, a discovery application in an ITAM system is a tool or feature used to automatically identify, track, and catalog the hardware and software assets within an organization's IT environment. This application helps maintain an up-to-date inventory of all IT assets, providing crucial information for managing these resources effectively, and typically includes the following functions:

Automated Scanning: The discovery tool continuously scans the network to detect all connected devices, such as servers, desktops, laptops, mobile devices, network equipment, and IoT devices.

Asset Identification: It identifies each device and collects detailed information about the hardware specifications (e.g., CPU, RAM, storage) and installed software (e.g., operating system, applications).

Inventory Management: The gathered data is used to create and maintain an inventory of IT assets, including their configurations, usage, and ownership. This helps organizations track assets throughout their lifecycle, from procurement to retirement.

License Compliance: For software assets, the discovery application helps to track software licenses.

Change Management: By continuously monitoring the IT environment, the discovery application can detect changes, such as new devices added to the network or software updates. This aids in maintaining accurate records and supports change management processes.

Security: The discovery application can also help identify unauthorized devices or software, potentially indicating security risks that need to be addressed.

Integration: Discovery applications often integrate with other IT management tools, such as Configuration Management Databases (CMDBs), to provide a more comprehensive view of the IT infrastructure.

The combination of ITAM and Discovery is an enabling support process to identify all of the assets on a host. The discovery process may read files, versions, size, and/or any other metadata available on the host. This collected data may then be leveraged as the reality to compare to the planned version previously captured, as described in detail herein.

Those with skill in the art will appreciate that inventive concepts described herein may work with various system configurations. In addition, various embodiments of this disclosure may be made in hardware, firmware, software, or any suitable combination thereof. Aspects of this disclosure may also be implemented as instructions stored on a machine-readable medium, which may be read and executed by one or more processors. A machine-readable medium may include any mechanism for storing or transmitting information in a form readable by a machine (e.g., a computing device, or a signal transmission medium), and may include a machine-readable transmission medium or a machine-readable storage medium. For example, a machine-readable storage medium may include read only memory, random access memory, magnetic disk storage media, optical storage media, flash memory devices, and others. Further, firmware, software, routines, or instructions may be described herein in terms of specific exemplary embodiments that may perform certain actions. However, it will be apparent that such descriptions are merely for convenience and that such actions in fact result from computing devices, processors, controllers, or other devices executing the firmware, software, routines, or instructions. These and other features are described in detail herein with reference to the foregoing figures.

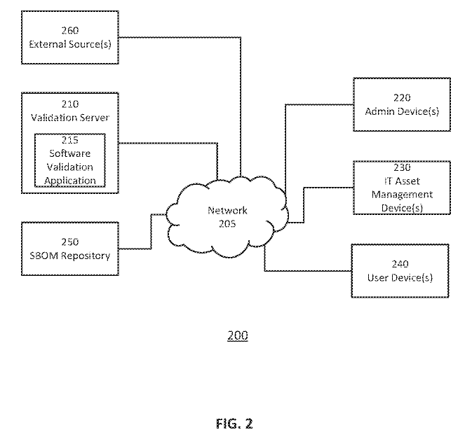

FIG. 2 depicts an illustrative system for validating a software package, in accordance with at least one embodiment. FIG. 2 illustrates a functional block diagram of an embodiment of a software validation system 200 within which at least some of the disclosed techniques may be implemented. The software validation system 200 may be established to permit the automated or semi-automated providing of software validation of software packages being deployed to various computing systems across network 205.

In some embodiments, various devices and applications described herein may be configured to communicate via network 205. In some embodiments, computing devices and servers described herein may communicate over network 205, which, in various embodiments, may be any of a diverse range of networks, each tailored to specific needs: Local Area Networks (LANs) linking devices within a confined area such as a home or office; Wide Area Networks (WANs) connecting devices across larger geographical areas, such as cities or countries; Metropolitan Area Networks (MANs) serving as intermediaries, connecting LANs within a city or region; wireless networks; cellular networks; Storage Area Networks (SANs); and/or Virtual Private Networks (VPNs) secure data over public networks. In some embodiments, network 205 may be any combination of the above, which may be a combination of private and public networks.

In some embodiments, each of the elements of software validation system 200 may be or may include applications executed on respective computing systems, though this need not always be the case. In some examples, one or more of the applications may be executed on a single computing system (which is not to suggest that such a computing system may not include multiple computing devices or nodes, or that each computing device or node need be co-located; indeed, a computing system including multiple servers that house multiple computing devices may be operated by a single entity and the multiple servers may be distributed, e.g., geographically). For example, in some embodiments, an entity may execute a software validation application on a server or other computing system, e.g., validation server 210. Moreover, in some examples, the entity may also provide users access to a validation application on various user devices (e.g., devices 220, 230, and/or 240, described herein), which may be a web-based application hosted by a computing system managed by or provisioned by the entity, or which communicates with such a computing system via an application programming interface (API). Accordingly, one or more of the devices/systems/elements depicted herein may communicate with one another via messages transmitted over network 205, such as the Internet and/or various other local area networks. For example, one or more applications may communicate via messages transmitted over network 205.

In some example embodiments, validation server 210 may include, host, or otherwise execute a software validation application 215. In some embodiments, software validation application 215 may be a user facing application with which a user interfaces to access various aspects of the systems and methods described herein. For example, an administrator of an entity or organization may use an admin device 220 to access features of software validation application 215 described herein, e.g., to initiate and execute a software validation process, as described herein, adjust settings, etc. Likewise, various users and ITAM personnel may access, interact with, and/or communicate with software validation application 215 from ITAM devices 230, user devices 240, respectively, as described herein. The software validation application 215 and users of the system (e.g., administrators, users, managers, etc.) may be isolated from accessing some or all of the features and/or information associated with the software validation application 215, except as described herein. For example, some users may be able to execute features of software validation application 215, whereas others may only be able to view results.

In some embodiments, software validation application 215 may include a user interface through which a user may interact with software validation system 200 via various user devices, e.g., devices 220, 230, and 240. For example, an administrator may desire to deploy a software program in an environment for a group of users. According to embodiments, the administrator, using admin device 220 may interact with a user interface of software validation application 215, retrieve or otherwise select the software package to be deployed, and execute software validation application 215 on validation server 210, to begin the process, as described herein. In some embodiments, an administrator may use admin device 220 to set up a scheduled execution of software validation application 215, e.g., daily, weekly, etc. In some embodiments, the software validation process described herein may be scheduled, e.g., so as to avoid system drain by not running during peak periods. In some embodiments, execution on a schedule may function as a confirmation that the environment has not been tampered, as described in detail herein. In some embodiments, continuous monitoring may be provided, while in other embodiments, the validation process may be restricted to certain parts of the system. In some embodiments, data may be stored locally, rather than sent to a remote database, e.g., to allow for scanning directory structures regularly.

In some example embodiments, software validation application 215 may be configured to coordinate with ITAM device 230 and SBOM Repository 250, to acquire (e.g., from external source(s) 260), validate, and distribute software to one or more user devices 240, e.g., of an organization. As explained above, ITAM device 230 is configured to enable applications such as software validation application 215 to track financial, contractual, and inventory data of IT assets across their lifecycle. SBOM Repository 250, as understood herein, is a metadata repository for all SBOMs to be registered and reviewed when a software package is built. As explained herein, lookups may be executed against the registry repository providing a full listing of software artifacts that must be included to achieve the composite artifact.

In some embodiments, SBOM Repository 250 may be stored or otherwise configured such that it may enable only restricted access and provide data integrity. For example, in some embodiments, SBOM Repository 250 may be hosted in a cloud-based or on-premise secure server, and/or may be configured with stringent access controls, e.g., employing role-based access control (RBAC) to limit who within the organization can view, modify, or manage the SBOM Repository. In some embodiments, access may be restricted to key personnel such as managers, administrators, developers, security teams, legal and compliance officers, and/or DevOps engineers. Such restrictions may prevent unauthorized changes or access to sensitive information about the software’s components, which may negatively impact the verification processes and/or expose an organization to security risks or license violations.

In some embodiments, the repository may be hosted on a secure cloud infrastructure (e.g., AWS, Azure, or a private cloud) with encryption at rest and/or in transit such that the data may be protected from external threats. Alternatively, it may reside on an on-premise secure server, e.g., behind a firewall, and within an organization’s internal network, for organizations requiring higher levels of control or compliance with regulatory standards. Access to SBOM Repository 250 may be further secured, e.g., through multi-factor authentication (MFA), such that any access is traceable. This approach protects the integrity of the SBOMs registered therein, maintaining security and compliance within the software supply chain.

It should be noted that, in some embodiments, ITAM 230 may be part of or otherwise integrated with validation server 210 and/or software validation application 215, and may not be a standalone device/system. Likewise, in some embodiments, SBOM Repository 250 may be part of or otherwise integrated with validation server 210 and/or software validation application 215, and may not be a standalone device, system, and/or database.

In some embodiments, external sources 260 may be any external source from which a software package may be acquired, e.g., software vendors, APIs, other organizations, or even other separate systems within an organization, etc.

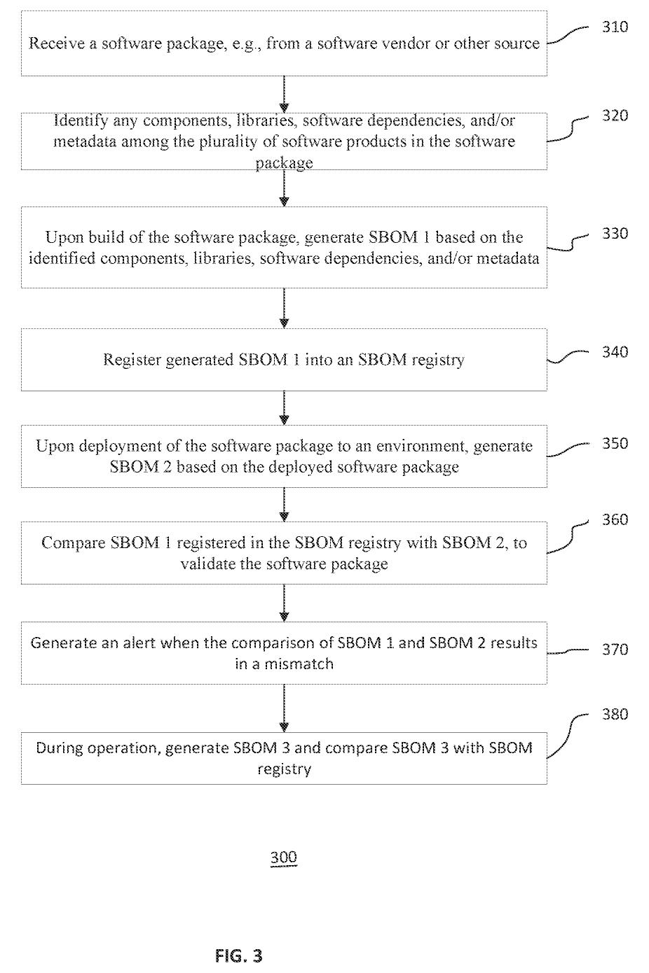

These and other features of software validation system 200 will be further understood with reference to the software validation method 300 of FIG. 3, herein.

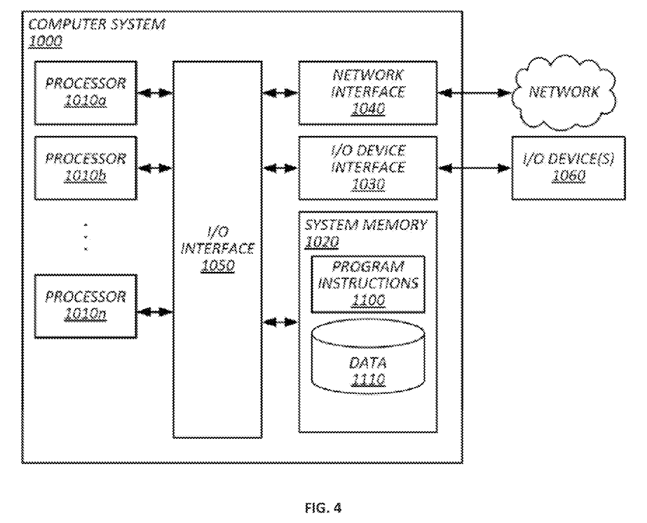

FIG. 3 depicts an example method for providing validation of a software package, in accordance with at least one embodiment. In various embodiments, method 300 may be implemented by software validation system 200, executing code in one or more processors therein. For example, in some embodiments, method 300 may be performed on a computer (e.g., computer system 1000 of FIG. 4) having one or more processors (e.g., processor(s) 1010 of FIG. 4) and memory (e.g., system memory 1020 of FIG. 4), and one or more code sets, applications, programs, modules, and/or other software stored in the memory and executing in or executed by one or more of the processor(s).

Method 300 begins at step 310 when a processor (e.g., of validation server 210) receives a software package, e.g., from a software vendor or other source, e.g., an internal software development team, etc. In some embodiments, as described in detail herein, the software package may include therein one or more, e.g., a plurality, of software products. As noted above with respect to FIG. 1, a piece of software may be composed of one or a number of additional pieces of software, with dependent relationships between various pieces of software that have primary and/or transitive software dependencies with one another.

At step 320, in some embodiments, the processor may be configured to identify any components, libraries, software dependencies, and/or metadata among the plurality of software products in the software package. In some embodiments, the processor may be configured to identify at least one of primary or transitive software dependencies between various software products in the software package. Understanding the dependency chain enables validation to maintain a hygienic environment without requiring validation of the software’s functionality. Instead, the validation process confirms the software’s signature matches the registered signatures in the SBOM registry, as described herein.

At step 330, in some embodiments, upon build of the software package, the processor may be configured to generate a first SBOM, (denoted herein as SBOM 1 for clarity), based on the identified components, libraries, software dependencies, and/or metadata. In some embodiments, this process may be executed as part of a Continuous Integration (CI). CI and Continuous Delivery/Continuous Deployment are both practices aimed at improving the efficiency and quality of software development, focusing on different stages of the process. CI, as understood herein, involves automatically integrating code changes, e.g., from multiple developers, into a shared repository frequently, often several times a day. With CI, each code update triggers an automated build and a series of tests to enable the code to integrate smoothly with the existing codebase. This practice may help detect integration issues early, providing developers with immediate feedback on whether their code is compatible and functioning correctly. Accordingly, in some embodiments, during CI, the software product may be built from code into binary. At this stage, an initial declaration of an SBOM, SBOM 1, may be made for which all subsequent comparisons may be made, as described herein.

At step 340, in some embodiments, the generated SBOM, SBOM 1, may be registered into an SBOM registry, e.g., SBOM registry 250, to track the metadata of the attributes of the binaries, as described herein. In some embodiments, SBOM may be stored in a dedicated SBOM repository, rather than being integrated into the version control system alongside the source code. Typically, SBOMs are saved in standard formats such as SPDX (Software Package Data Exchange), CycloneDX, or SWID (Software Identification Tags), and stored as a plain-text file (e.g., .json, .xml, or .spdx) within the project's root directory. However, this leaves the SBOM vulnerable to tampering or manipulation. Accordingly, in some embodiments, the generated SBOM, SBOM 1, may be registered to a secure repository which can then be accessed for comparison purposes throughout the CI/CD processes, to validate the software, as described herein.

At step 350, in some embodiments, upon deployment of the software package to an environment, the processor may be configured to generate a second SBOM (denoted SBOM 2 herein for clarity) based on the deployed software package. In some embodiments, this step may be implemented during Continuous Delivery (CD), which may extend the automation beyond just integration and testing, such that the software is always in a deployable state. With Continuous Delivery, after the code has successfully passed all tests in the CI pipeline, it may be packaged and prepared for deployment to production or other environments. However, in this practice, the actual deployment to production may require manual approval. In some embodiments, this step may be implemented during Continuous Deployment, a step beyond Continuous Delivery, which automates this final phase. In Continuous Deployment, code that passes all tests and checks in the CI/CD pipeline is automatically deployed to the production environment without any manual intervention. This may allow for more frequent and faster releases but may also require a high level of trust in the automation and testing processes. CI enables code to be integrated and tested regularly, Continuous Delivery enables code to be ready for deployment, and Continuous Deployment automates the release process entirely.

In some embodiments, the second generated SBOM, SBOM 2, is generated based on the deployed software (e.g., the software deployed to the environment) rather than being generated based on the built software. In some embodiments, as with SBOM 1, the processor may be configured to identify any components, libraries, software dependencies, and/or metadata among the deployed software. In some embodiments, the processor may be configured to identify at least one of primary or transitive software dependencies between various software products in the deployed software. In some embodiments, the deployed software may be declared, e.g., the deployment process may output the data it finds in the build instructions, and this output may be used to generate the second SBOM, SBOM 2. In some embodiments, SBOM 2 may also be registered to the SBOM registry.

In some embodiments, SBOM may declare all of the products that make up the binary(s) delivered to the environment. This SBOM, SBOM 2 declared all of the binary packages specified in the build script of the software. For example, in some embodiments, it may be the entire software stack and register the complete dependency chain of the delivered product.

In some embodiments, at step 360, the processor may be configured to compare the first SBOM, SBOM 1, registered in the SBOM registry, with the second SBOM, SBOM 2, to validate the software package. In some embodiments, when comparing the first SBOM and the second SBOM, the processor may be configured to compare metadata attributes of each SBOM; and confirm whether the metadata attributes are the same for the first SBOM, SBOM 1, and the second SBOM, SBOM 2.

In some embodiments, the processor may be configured to verify that all identified primary and transitive software dependencies match between the first SBOM, SBOM 1, and the second SBOM, SBOM 2. For example, in some embodiments, individually at deployment, each software product must be evaluated and compared against the SBOM registry to the originally declared SBOM, SBOM 1. By iterating through the stack, this will confirm that each product is the one intended from the original build, and that the software package as a whole, is valid. In some embodiments, the primary dependencies that are listed in the respective SBOMs and the transitive dependencies that are embedded within the primaries may be compared. This may help verify that the entire set of products originally listed in the SBOM registry in SBOM 1 are the complete set of products delivered, no more and no less.

In some embodiments, to compare the two SBOMs to determine if they are the same, the key elements of both SBOMs, such as the component names, versions, licenses, and dependency relationships, may be analyzed. This process may involve comparing each component's name and version to check for exact matches. Additionally, hashes (unique identifiers) of the components may be compared to confirm whether or not the binaries or source code of the components are identical. If the SBOMs include vulnerability data, in some embodiments, the comparison may also involve checking for differences in reported vulnerabilities. In some embodiments, a line-by-line comparison of components and metadata may be performed. Differences in the SBOMs may indicate updates, new components, or different versions of the same software, and these changes may highlight whether the software is truly the same or has undergone modifications. The comparison may enable licensing and security postures to remain consistent between the originally built software and the software as deployed.

At step 370, in some embodiments, if the comparison of SBOM 1 and SBOM 2 results in a mismatch, the processor may be configured to generate an alert. For example, when comparing two SBOMs and detecting a mismatch, an alert may be generated automatically by the processor, e.g., implementing an SBOM management or security tool. In some embodiments, the type of alert may depend on the nature of the mismatch. For instance, if a version mismatch is detected between components, an alert may be raised to notify developers or security teams of potential updates or regressions in the software. Similarly, if there’s a license discrepancy, such as switching from a permissive license to a restrictive one, an alert may flag a potential compliance issue that requires review by appropriate subject matter experts.

In some embodiments, other types of alerts may include vulnerability alerts if one SBOM includes components with known vulnerabilities that are not present in the other. This could trigger a security alert to address the newly introduced risks. Additionally, alerts may be triggered if there is a missing component in one SBOM that is present in the other, indicating potential supply chain issues or incomplete builds. Alerts may be sent through various channels, such as, for example, email notifications, integration into ticketing systems (e.g., Jira), or through dashboards in CI/CD pipelines, enabling timely action based on the specific mismatch type. In some embodiments, if the match identifies breaks, an alert may be sent, e.g., to a manager or other user, identifying the break and requesting remediation.

At step 380, in some embodiments, during operation, the processor may be configured to scan the environment for the deployed software package, generate a third SBOM (denoted herein as SBOM 3 for clarity) and compare the first SBOM registered in the SBOM registry with the third SBOM to revalidate the software package. In some embodiments, as with SBOM 1 and SBOM 2, the processor may be configured to identify any components, libraries, software dependencies, and/or metadata among the operating software. In some embodiments, the processor may be configured to identify at least one of primary or transitive software dependencies between various software products in the operating software. Once the software package has been built and deployed to an environment, in some embodiments, ongoing Scheduled Drift Validation may be implemented. For example, in some embodiments, ITAM may execute a discovery and when the discovery is complete, a third SBOM, SBOM 3, may be generated and comparison may be executed to compare the discovered software stack with the SBOM registry and determine if they match.

In some embodiments, the processor may compare every item in the dependency chain and validate that the dependency is expected and has not been tampered. In some embodiments, SBOM 3 may be compared with SBOM 1. In some embodiments, SBOM 3 may be compared with SBOM 2. In this regard, it should be understood that over time (e.g., at various intervals, scheduled times, or on demand) additional SBOMs may be generated based on the software discovered in the environment, and these additional SBOMs may be compared against any previously generated SBOM. Furthermore, in some embodiments, each generated SBOM may be registered in the SBOM registry, providing a complete accounting of the software package throughout its life cycle.

In some embodiments, the matching process may compare metadata attributes like name, size, date modified, etc., to validate the package deployed to the package registered at the time of build. If the match identifies breaks, an alert (e.g., as described herein) may be sent identifying the break and/or requesting/requiring remediation. In some embodiments, the processor may be configured to implement audit logging (e.g., at any stage of the methods described herein), enabling any modifications to the SBOM registry (e.g., SBOM Repository 250) to be recorded and/or made traceable.

Embodiments described herein may enable acquiring and distributing software into an organization such that the acquired package is not manipulated or tampered as it is deployed, or any time thereafter while the software is in operation. Furthermore, upon deployment, the deployed Software may be tested, e.g., regularly, on a schedule, and/or on demand, against a known good to confirm that it has not been tampered with.

Some embodiments may execute the above operations on a computer system, such as the computer system of FIG. 4, which is a diagram that illustrates a computing system 1000 in accordance with embodiments of the present techniques. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus may also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine-readable storage device, a machine-readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g., within a data center or geographically), or otherwise differently organized. The functionality described herein may be provided by one or more processors of one or more computers executing code stored on a tangible, non-transitory, machine readable medium. In some cases, notwithstanding use of the singular term "medium," the instructions may be distributed on different storage devices associated with different computing devices, for instance, with each computing device having a different subset of the instructions, an implementation consistent with usage of the singular term “medium” herein. In some cases, external (e.g., third party) content delivery networks may host some or all of the information conveyed over networks, in which case, to the extent information (e.g., content) is said to be supplied or otherwise provided, the information may be provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or "a element" includes a combination of two or more elements, notwithstanding use of other terms and phrases for one or more elements, such as “one or more.” The term "or" is, unless indicated otherwise, non-exclusive, i.e., encompassing both "and" and "or." Terms describing conditional relationships, e.g., "in response to X, Y," "upon X, Y,", “if X, Y,” "when X, Y," and the like, encompass causal relationships in which the antecedent is a necessary causal condition, the antecedent is a sufficient causal condition, or the antecedent is a contributory causal condition of the consequent, e.g., "state X occurs upon condition Y obtaining" is generic to "X occurs solely upon Y" and "X occurs upon Y and Z." Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B may include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X’ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like "parallel," "perpendicular/orthogonal," “square”, “cylindrical,” and the like, should be construed as encompassing items that substantially embody the properties of the geometric construct, e.g., reference to "parallel" surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms "first", "second", "third," “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and may be implemented in the form of data that causes functionality to be invoked, e.g., in the form of arguments of a function or API call. To the extent bespoke noun phrases are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

While the systems and methods described herein have generally be described with respect to a single legacy language being translated to a modernized coding language (e.g., one-to-one translation of a first language to a second language), in various embodiments, the same processes may be implemented in a one-to-many framework. For example, in some embodiments, a user may indicate one or more second languages to which a first language is to be translated. Additionally or alternatively, in some embodiments, one or more translation recommendations may be provided (as described herein) for multiple translations. In either event, embodiments of the systems and methods described herein may be configured to process multiple translations, e.g., in parallel and/or in series (e.g., based on an identified priority), as described herein.

This written description uses examples to disclose the implementations, including the best mode, and to enable any person skilled in the art to practice the implementations, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method for validating a software package, comprising:
receiving, by a processor, a software package, wherein the software package comprises a plurality of software products;
identifying, by the processor, any components, libraries, software dependencies, or metadata among the plurality of software products in the software package;
upon build of the software package, generating, by the processor, a first software bill of materials (SBOM) based on the identified components, libraries, software dependencies, or metadata;
registering, by the processor, the first SBOM in an SBOM registry;
upon deployment of the software package to an environment, generating, by the processor, a second SBOM based on the deployed software package; and
comparing, by the processor, the first SBOM registered in the SBOM registry with the second SBOM to validate the software package.

2. The method as in claim 1, wherein, when identifying software dependencies of the software package, the processor is configured to identify at least one of primary or transitive software dependencies between various software products in the software package.

3. The method as in claim 2, wherein, when comparing the first SBOM and the second SBOM, the processor is further configured to verify that all identified primary and transitive software dependencies match between the first SBOM and the second SBOM.

4. The method as in claim 1, further comprising:
during operation, scanning, by the processor, the environment for the deployed software package;
generating, by the processor, a third SBOM; and
comparing, by the processor, the first SBOM registered in the SBOM registry with the third SBOM to revalidate the software package.

5. The method as in claim 1, further comprising generating an alert when the comparison of the first SBOM and second SBOM results in a mismatch.

6. The method as in claim 4, further comprising generating an alert when the comparison of the first SBOM and third SBOM results in a mismatch.

7. The method as in claim 1, wherein, when comparing the first SBOM and the second SBOM, the processor is configured to compare metadata attributes of each SBOM; and confirm whether the metadata attributes are the same for the first SBOM and the second SBOM.

8. The method as in claim 4, wherein, when comparing the first SBOM and the third SBOM, the processor is configured to compare metadata attributes of each SBOM; and confirm whether the metadata attributes are the same for the first SBOM and the third SBOM.

9. A system for validating a software package, comprising:
memory storing computer program instructions; and
one or more processors configured to execute the computer program instructions to:
receive a software package, wherein the software package comprises a plurality of software products;
identify any components, libraries, software dependencies, or metadata among the plurality of software products in the software package;
upon build of the software package, generate a first software bill of materials (SBOM) based on the identified components, libraries, software dependencies, or metadata;
register the first SBOM in an SBOM registry;
upon deployment of the software package to an environment, generate a second SBOM based on the deployed software package; and
compare the first SBOM registered in the SBOM registry with the second SBOM to validate the software package.

10. The system as in claim 9, wherein, when identifying software dependencies of the software package, the one or more processors are configured to identify at least one of primary or transitive software dependencies between various software products in the software package.

11. The system as in claim 10, wherein, when comparing the first SBOM and the second SBOM, the one or more processors are further configured to verify that all identified primary and transitive software dependencies match between the first SBOM and the second SBOM.

12. The system as in claim 9, further configured to:
during operation, scan the environment for the deployed software package;
generate a third SBOM; and
compare the first SBOM registered in the SBOM registry with the third SBOM to revalidate the software package.

13. The system as in claim 9, further configured to generate an alert when the comparison of the first SBOM and second SBOM results in a mismatch.

14. The system as in claim 12, further figured to generate an alert when the comparison of the first SBOM and third SBOM results in a mismatch.

15. The system as in claim 9, wherein, when comparing the first SBOM and the second SBOM, the one or more processors are configured to compare metadata attributes of each SBOM; and confirm whether the metadata attributes are the same for the first SBOM and the second SBOM.

16. The system as in claim 12, wherein, when comparing the first SBOM and the third SBOM, the one or more processors are configured to compare metadata attributes of each SBOM; and confirm whether the metadata attributes are the same for the first SBOM and the third SBOM.

17. A non-transitory computer readable medium having instructions recorded thereon for validating a software package, the instructions when executed by a computer having at least one programmable processor cause operations comprising:
receiving, by the processor, a software package, wherein the software package comprises a plurality of software products;
identifying, by the processor, any components, libraries, software dependencies, or metadata among the plurality of software products in the software package;
upon build of the software package, generating, by the processor, a first software bill of materials (SBOM) based on the identified components, libraries, software dependencies, or metadata;
registering, by the processor, the first SBOM in an SBOM registry;
upon deployment of the software package to an environment, generating, by the processor, a second SBOM based on the deployed software package; and
comparing, by the processor, the first SBOM registered in the SBOM registry with the second SBOM to validate the software package.

18. The non-transitory computer readable medium as in claim 17, wherein, when identifying software dependencies of the software package, the processor is configured to identify at least one of primary or transitive software dependencies between various software products in the software package.

19. The non-transitory computer readable medium as in claim 18, wherein, when comparing the first SBOM and the second SBOM, the processor is further configured to verify that all identified primary and transitive software dependencies match between the first SBOM and the second SBOM.

20. The non-transitory computer readable medium as in claim 17, further comprising:
during operation, scanning, by the processor, the environment for the deployed software package;
generating, by the processor, a third SBOM; and
comparing, by the processor, the first SBOM registered in the SBOM registry with the third SBOM to revalidate the software package.
